(19) United States
(12) Patent Application Publication
(10) Pub. No.: US 2026/0300244 A1
(43) Pub. Date: Oct. 1, 2026

(54) SYSTEM AND METHOD FOR EFFICIENT STORAGE AND VERSION CONTROL OF MACHINE LEARNING DATASETS USING HYBRID DELTA ENCODING

(71) Applicant: NBHD.AI, INC., Baltimore, MD (US)

(72) Inventor: Stephen CATTELL, Baltimore, MD (US)

(73) Assignee: NBHD.AI, INC., Baltimore, MD (US)

(21) Appl. No.: 19/629,997

(22) Filed: Mar. 26, 2026

Related U.S. Application Data
(60) Provisional application No. 63/779,146, filed on Mar. 27, 2025.

(51) Int. Cl. G06F 16/21; G06F 16/22; G06F 16/23

(52) U.S. Cl. CPC G06F 16/219; G06F 16/221; G06F 16/2379

(57) ABSTRACT

Systems and methods for efficient storage and version control of machine learning datasets are disclosed. A system can store dataset information in a data storage layer in a columnar format. The system can store version metadata in a header storage layer. The system can generate, in response to a commit request comprising changes relative to a prior dataset version, at least one new delta-encoded block in the chain of data blocks for at least one column identified as modified and a new header file. The system can, in response to a query for a requested dataset version, reconstruct data for at least one column by identifying a header file corresponding to the requested dataset version and processing delta-encoded blocks in the chain of data blocks for the at least one column relative to a full-data block.

### CROSS-REFERENCE TO RELATED APPLICATIONS

This application claims priority to U.S. Provisional Patent Application Ser. No. 63/779,146, filed Mar. 27, 2025, which is incorporated by reference in its entirety.

### BACKGROUND

Machine learning model evaluations can use datasets that contain input data paired with expected outputs or evaluation criteria. These datasets can grow over time as new commits are added or existing versions are modified to improve evaluation coverage. Managing large and evolving datasets presents challenges in storage efficiency, version tracking, and collaborative development workflows.

### SUMMARY

Machine learning datasets can require version control to track changes to training data, evaluation data, or other data used in model development workflows. Datasets used for machine learning evaluations can grow in size as additional test cases are added, existing test cases are modified, or new data types are incorporated to improve evaluation coverage. Traditional version control systems can face limitations when applied to machine learning datasets. Systems that store complete objects indexed by hash values can provide fast checkout operations but can be inefficient for large files due to storage redundancy. Systems that use delta encoding can store initial objects and sequential updates to achieve space efficiency but can be slower for accessing specific versions due to the need to reconstruct data through chains of delta operations. Existing approaches can be insufficient for structured data types, non-textual data such as numerical arrays or binary data, or collaborative workflows where multiple users need to update datasets efficiently.

The techniques described herein can provide a hybrid version control approach that combines content-addressable storage for metadata with delta encoding for columnar data to address limitations in storing and versioning machine learning datasets. The techniques can organize dataset information in a columnar format where each column corresponds to a chain of data blocks that includes full-data blocks and delta-encoded blocks, such that the system can store dataset versions efficiently while maintaining fast access to current data. A header storage layer can maintain version metadata through content-addressable header files that map columns to head blocks in the chains, such that schema information and data content can be versioned independently. The techniques can use a main-head block containing a full encoding of column data as a reference point for reconstructing multiple dataset versions, such that reconstruction operations can process delta-encoded blocks relative to the main-head block without requiring traversal of the entire version history. The system can migrate the main-head block based on usage metrics such as access frequency or delta chain length, such that frequently accessed versions can be reconstructed more efficiently. The techniques can support selective column loading during reconstruction based on queries specifying subsets of columns, such that memory requirements can be minimized for operations that do not require the full dataset.

In one embodiment, a system for efficient storage and version control of machine learning datasets that reduces storage usage and reconstruction latency may comprise at least one processing resource; and a computer-readable medium storing instructions that, when executed by the at least one processing resource, may cause the system to: store dataset information in a data storage layer in a columnar format including a plurality of columns, each column corresponding to a chain of data blocks including at least one full-data block and at least one delta-encoded block, the at least one delta-encoded block including operations to modify a preceding block store version metadata in a header storage layer, the version metadata including at least one header file of a plurality of content-addressable header files, the at least one header file representing a dataset version and including column metadata mapping at least one column to a head block in the chain of data blocks; generate, in response to a commit request including changes relative to a prior dataset version, at least one new delta-encoded block in the chain of data blocks for at least one column identified as modified and a new header file representing a new dataset version, the new header file including column metadata mapping the at least one column to a head block in the chain of data blocks; and in response to a query for a requested dataset version, reconstruct data for at least one column by identifying a header file corresponding to the requested dataset version and processing delta-encoded blocks in the chain of data blocks for the at least one column relative to a full-data block.

In some aspects, the chain of data blocks for at least one column may further include a main-head block including a full encoding of the column, and the instructions that, when executed by the at least one processing resource, may cause the system to: select the main-head block as a reference block for reconstructing data for a plurality of dataset versions for the at least one column; and process, for the plurality of dataset versions, delta-encoded blocks in the chain of data blocks relative to the main-head block to obtain reconstructed data.

In some aspects, migrating the main-head block may include: monitoring version metadata for a plurality of dataset versions to determine at least one usage metric including at least one of a number of accesses to a dataset version and a length of a delta chain from the main-head block; and selecting, as a new main-head block, a full-data block in the chain of data blocks for the at least one column in response to the usage metric satisfying a trigger condition including at least one of exceeding a threshold number of accesses and exceeding a threshold delta chain length, and updating the version metadata to record the new main-head block.

In some aspects, the full-data block for at least one column includes data encoded in a first storage format, and the instructions that, when executed by the at least one processing resource, may cause the system to: store the full-data block encoded in a compressed storage format in a first storage environment associated with a repository server; and store a corresponding full-data block for the at least one column encoded in a second storage format optimized for memory-mapped access in a second storage environment associated with an inference server.

In some aspects, the operations of the at least one delta-encoded block may include: a keep operation specifying a range of keep rows by an offset and a count configured to execute during reconstruction by copying values from the prior dataset version for the range of keep rows without decoding additional data; a delete operation specifying a range of delete rows to be removed from a prior dataset version configured to execute during reconstruction by removing the range of delete rows; an update operation including replacement data values encoded in a compressed format configured to execute during reconstruction by decoding the replacement data values and overwriting corresponding values obtained from a full-data block or a prior delta-encoded block; and an insert operation including insert data values encoded in the compressed format, and at least one location, the insert operation configured to execute during reconstruction by decoding the inserted data values and placing the inserted data values at the at least one location.

In some aspects, at least one column may include a nested data type including a parent column and at least one child column, and the instructions that, when executed by the at least one processing resource, may cause the system to: store the nested data type as a plurality of chains of data blocks including a chain for the parent column and a chain for the at least one child column; and propagate, during reconstruction of the nested data type, an operation, triggered on the parent column, to the at least one child column.

In some aspects, generating the at least one delta-encoded block may include: reconstructing data for the prior dataset version for the plurality of columns based at least on a header file representing the prior dataset version; comparing local data for the plurality of columns with reconstructed data for the prior dataset version to determine a subset of columns identified as modified; and generating the at least one delta-encoded block for the subset of columns, the at least one delta-encoded block corresponding to an operation configured to generate a current full-data block for a current dataset version.

In some aspects, storing the version metadata may further include: associating at least one header file with branch metadata identifying a branch name and a parent dataset version; and maintaining, in the header storage layer, a directed acyclic graph of dataset versions including a base dataset version and a plurality of child dataset versions, each child dataset version recorded with a reference to a parent header file in the directed acyclic graph.

In some aspects, merging dataset versions may include: identifying a first branch and a second branch including different sequences of header files extending from a common ancestor dataset version; determining differences between a latest dataset version of the first branch and a latest dataset version of the second branch for at least one column; and generating a merged dataset version including a merged header file and at least one delta-encoded block encoding merged changes relative to the common ancestor dataset version.

In some aspects, reconstructing data for the requested dataset version may include: receiving a query specifying a subset of columns for the requested dataset version; identifying column metadata in a header file corresponding to the requested dataset version for only the subset of columns; and reconstructing data only for the subset of columns by processing delta-encoded blocks in the chains of data blocks corresponding to the subset of columns.

In another embodiment, a method for efficient storage and version control of machine learning datasets that reduces storage usage and reconstruction latency may include: storing, by at least one processing circuit, dataset information in a data storage layer in a columnar format including a plurality of columns, each column corresponding to a chain of data blocks including at least one full-data block and at least one delta-encoded block, the at least one delta-encoded block including operations to modify a preceding block including at least one of at least one keep operation, at least one delete operation, at least one update operation, and at least one insert operation; storing version metadata in a header storage layer, the version metadata including a plurality of content-addressable header files, at least one header file representing a dataset version and including column metadata mapping at least one column to a head block in the chain of data blocks; generating, in response to a commit request including changes relative to a prior dataset version, at least one new delta-encoded block in the chain of data blocks for at least one column identified as modified and a new header file representing a new dataset version, the new header file including column metadata mapping the at least one column to a head block in the chain of data blocks; and in response to a query for a requested dataset version, reconstructing data for at least one column for a requested dataset version by identifying a header file corresponding to the requested dataset version and processing delta-encoded blocks in the chain of data blocks for the at least one column relative to a full-data block.

In some aspects, the method may further include storing, for at least one column, a main-head block in the chain of data blocks, the main-head block including a full encoding of the at least one column; selecting the main-head block as a reference block for reconstructing data for a plurality of dataset versions for the at least one column; and processing, for the plurality of dataset versions, delta-encoded blocks in the chain of data blocks relative to the main-head block to obtain reconstructed data.

In some aspects, the method may further include monitoring version metadata for a plurality of dataset versions to determine at least one usage metric including at least one of a number of accesses to a dataset version and a length of a delta chain from the main-head block; and selecting, as a new main-head block, a full-data block in the chain of data blocks for the at least one column in response to the at least one usage metric satisfying a trigger condition including at least one of exceeding a threshold number of accesses and exceeding a threshold delta chain length, and updating the version metadata to record the new main-head block.

In some aspects, the method may further include encoding a full-data block for at least one column in a first storage format; storing the full-data block encoded in a compressed storage format in a first storage environment associated with a repository server; and storing a corresponding full-data block for the at least one column encoded in a second storage format optimized for memory-mapped access in a second storage environment associated with an inference server.

In some aspects, the operations of the at least one delta-encoded block for at least one column include a keep operation specifying a range of keep rows by an offset and a count, a delete operation specifying a range of delete rows, an update operation including replacement data values encoded in a compressed format, and an insert operation including insert data values encoded in the compressed format and at least one location, the method further including: executing the keep operation during reconstruction by copying values from the prior dataset version for the range of keep rows without decoding additional data; executing the delete operation during reconstruction by removing the range of delete rows from reconstructed data; executing the update operation during reconstruction by decoding the replacement data values and overwriting corresponding values obtained from a full-data block or a prior delta-encoded block; and executing the insert operation during reconstruction by decoding the insert data values and placing the insert data values at the at least one location.

In some aspects, generating the at least one delta-encoded block includes: reconstructing data for the prior dataset version for a plurality of columns based at least on a header file representing the prior dataset version; comparing local data for the plurality of columns with reconstructed data for the prior dataset version to determine a subset of columns identified as modified; and generating the at least one delta-encoded block for the subset of columns, the at least one delta-encoded block corresponding to an operation configured to generate a current full-data block for a current dataset version.

In some aspects, the method may further include associating at least one header file with branch metadata identifying a branch name and a parent dataset version; maintaining, in the header storage layer, a directed acyclic graph of dataset versions including a base dataset version and a plurality of child dataset versions, each child dataset version recorded with a reference to a parent header file in the directed acyclic graph; identifying a first branch and a second branch including different sequences of header files extending from a common ancestor dataset version; determining differences between a latest dataset version of the first branch and a latest dataset version of the second branch for at least one column; and generating a merged dataset version including a merged header file and at least one delta-encoded block encoding merged changes relative to the common ancestor dataset version.

In some aspects, reconstructing data for the requested dataset version may include receiving a query specifying a subset of columns for the requested dataset version; identifying column metadata in a header file corresponding to the requested dataset version for only the subset of columns; and reconstructing data only for the subset of columns by processing delta-encoded blocks in chains of data blocks corresponding to the subset of columns.

In yet another embodiment, a non-transitory, computer-readable medium may include instructions that, when executed by at least one processing resource, cause the at least one processing resource to: store dataset information in a data storage layer in a columnar format including a plurality of columns, each column corresponding to a chain of data blocks including at least one full-data block and at least one delta-encoded block, the at least one delta-encoded block including operations to modify a preceding block including at least one of at least one keep operation, at least one delete operation, at least one update operation, and at least one insert operation; store version metadata in a header storage layer, the version metadata including a plurality of content-addressable header files, at least one header file representing a dataset version and including column metadata mapping at least one column to a head block in the chain of data blocks; generate, in response to a commit request including changes relative to a prior dataset version, at least one new delta-encoded block in the chain of data blocks for at least one column identified as modified and a new header file representing a new dataset version, the new header file including column metadata mapping the at least one column to a head block in the chain of data blocks; and in response to a query for a requested dataset version, reconstruct data for at least one column for a requested dataset version by identifying a header file corresponding to the requested dataset version and processing delta-encoded blocks in the chain of data blocks for the at least one column relative to a full-data block.

In some aspects, the instructions, when executed by the at least one processing resource, may further cause the processing resource to: store, for at least one column, a main-head block in the chain of data blocks, the main-head block including a full encoding of the at least one column; select the main-head block as a reference block for reconstructing data for a plurality of dataset versions for the at least one column; and process, for the plurality of dataset versions, delta-encoded blocks in the chain of data blocks relative to the main-head block to obtain reconstructed data.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which can be carried on appropriate carrier media (computer readable media), which can be tangible carrier media (e.g., disks) or intangible carrier media (e.g., communications signals). Aspects can also be implemented using any suitable apparatus, which can take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram illustrating a storage and version control system for efficient storage and version control of machine learning datasets, according to an embodiment;

FIG. 2 is a flow chart illustrating a method for efficient storage and version control of machine learning datasets, according to an embodiment;

FIG. 3 is a block diagram illustrating a versioned column-data chain including a main-head full-data block, reverse delta blocks, forward delta blocks, and a branch, according to an embodiment; and

FIG. 4 is a schematic diagram illustrating header data for a versioned machine learning dataset, according to an embodiment.

### DETAILED DESCRIPTION

Below are detailed descriptions of various concepts related to, and approaches, methods, apparatuses, and systems for implementing the various techniques described herein. The various concepts introduced above and discussed in greater detail below can be implemented in any of numerous ways, as the described concepts are not limited to any particular manner of implementation. Examples of specific implementations and applications are provided primarily for illustrative purposes.

This disclosure relates to techniques for storing and version-controlling machine learning datasets using a hybrid approach that combines content-addressable metadata storage with delta-encoded columnar data storage. Machine learning systems can rely on datasets that contain input data, expected outputs, or evaluation criteria to train models or assess model performance. Datasets used for machine learning evaluations can grow in size as new test cases are added or existing test cases are modified to improve evaluation coverage. Various evaluation frameworks can store data in comma-separated value files, text files integrated in library code, Parquet files, or other formats. Machine learning datasets can include diverse data types such as structured data, numerical arrays, binary content, or textual information. Datasets can be organized in columnar formats where each column represents a distinct attribute or feature of the data. Version control systems can track changes to datasets over time to provide historical records of modifications. Traditional version control approaches can store complete objects indexed by hash values or can use delta encoding to store initial objects and sequential updates.

Existing version control systems can present challenges when applied to machine learning datasets. Systems that store complete objects indexed by hash values can provide fast checkout operations but can be inefficient for large files due to storage redundancy when dataset versions differ only slightly. Systems that use delta encoding can store initial objects and sequential updates to achieve space efficiency but can be slower for accessing specific versions due to the need to reconstruct data through chains of delta operations. Existing approaches can be insufficient for structured data types that include nested columns or parent-child relationships. Existing approaches can be insufficient for non-textual data such as numerical arrays or binary data such as images. Collaborative workflows where multiple users need to update datasets efficiently can face difficulties with existing version control systems. Datasets used for machine learning evaluations can have schema and metadata that change rarely while the actual data can be frequently appended or modified, such that storing the schema and data using the same versioning approach can result in inefficient storage or access patterns. Existing systems can require complete dataset transfers when only a subset of columns has been modified, resulting in increased bandwidth requirements and longer synchronization times.

The techniques described herein can provide a hybrid version control approach that combines content-addressable storage for metadata with delta encoding for columnar data to address limitations in storing and versioning machine learning datasets. The techniques can organize dataset information in a columnar format where each column corresponds to a chain of data blocks that includes full-data blocks and delta-encoded blocks, such that the system can store dataset versions efficiently while maintaining fast access to current data. A header storage layer can maintain version metadata through content-addressable header files that map columns to head blocks in the chains, such that schema information and data content can be versioned independently. The techniques can use a main-head block containing a full encoding of column data as a reference point for reconstructing multiple dataset versions, such that reconstruction operations can process delta-encoded blocks relative to the main-head block without requiring traversal of the entire version history. The method for efficient storage and version control of machine learning datasets that reduces storage usage and reconstruction latency can perform a step of the method by at least one processing circuit.

To implement the techniques described herein, a data storage layer can organize dataset information in a columnar format where each column corresponds to a separate chain of data blocks. Each chain of data blocks can include at least one full-data block that stores complete column data and at least one delta-encoded block that stores operations to modify a preceding block. Delta operations can include keep operations that retain rows from a previous version, delete operations that remove rows, update operations that replace data in entries, and insert operations that add new data rows. The system can store full-data blocks in different storage formats depending on deployment requirements, such that uncompressed formats can be used for memory-mapped access in inference environments and compressed formats can be used for reduced file size in repository environments. A header storage layer can maintain version metadata through content-addressable header files that are referenced by hash values. Each header file can represent a dataset version and can include metadata such as an evaluation function reference, dataset properties, and per-column metadata. Per-column metadata can include column name, datatype, nullability, and a head identifier that points to a specific block in the chain of data blocks for the column. The system can maintain a main-head block for each column that contains a full encoding of the column data, such that reconstruction operations for multiple dataset versions can use the main-head block as a reference point. When a commit request includes changes relative to a prior dataset version, the system can analyze the changes to determine which columns were modified, generate delta-encoded blocks for the modified columns, and create a new header file with updated column references. The system can migrate the main-head block to a different block in the chain based on usage metrics such as access frequency or delta chain length, such that frequently accessed versions can be reconstructed more efficiently.

The techniques described herein can provide technical improvements over existing version control approaches for machine learning datasets. The hybrid approach that combines content-addressable storage for metadata with delta encoding for columnar data can reduce storage requirements compared to approaches that store complete objects for each version while maintaining faster access to specific versions compared to approaches that require traversal of entire delta chains. The separation between header storage and data storage can provide independent versioning of schema information and data content, such that schema changes do not require regeneration of all column data and data changes do not require regeneration of header files when column structure remains unchanged. The main-head block approach can optimize reconstruction performance by providing a reference point that minimizes the number of delta operations required to reconstruct frequently accessed versions. The selective column loading capability can reduce memory requirements and bandwidth usage by reconstructing only the columns needed for a specific operation rather than loading entire dataset versions. The support for different storage formats in full-data blocks can provide deployment-specific optimizations, such that repository servers can use compressed formats for reduced storage costs while inference servers can use uncompressed formats for faster memory-mapped access. The delta operation approach that includes keep, delete, update, and insert operations can provide efficient encoding of dataset modifications while supporting diverse change patterns including row additions, removals, and modifications.

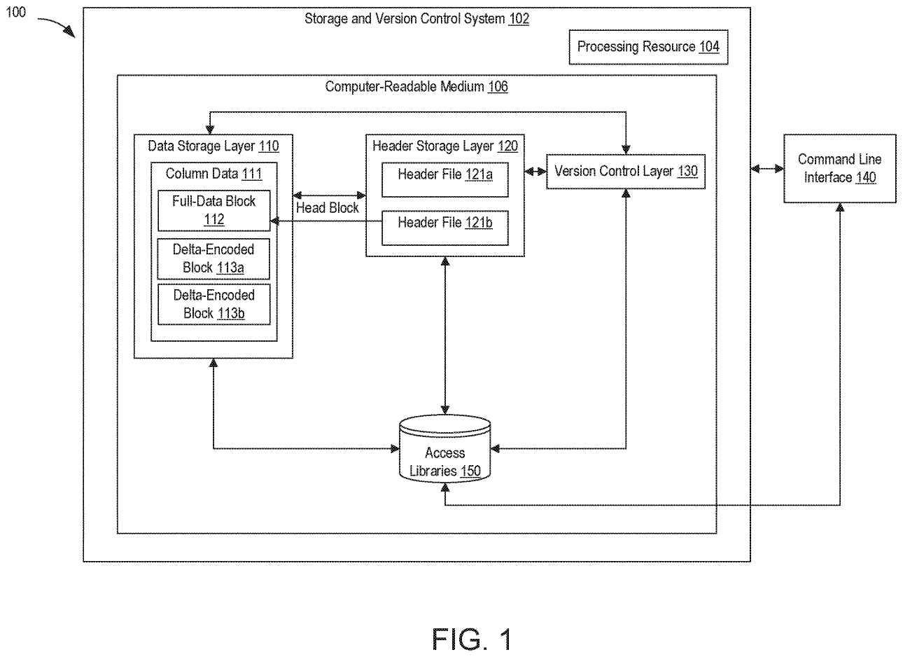

Referring now to FIG. 1, illustrated is a block diagram of a system 100 for efficient storage and version control of machine learning datasets. The system 100 can include a storage and version control system 102. The storage and version control system 102 can include at least one processing resource 104 and a computer-readable medium 106. The computer-readable medium 106 can include a data storage layer 110, a header storage layer 120, a version control layer 130, a command line interface 140, and access libraries 150. The data storage layer 110 can include column data 111. The column data 111 can include a full-data block 112, a delta-encoded block 113a, and a delta-encoded block 113b. The header storage layer 120 can include a header file 121a and a header file 121b.

The system 100 can include a storage and version control system 102. The storage and version control system 102 can be a computing system that implements hybrid version control techniques for machine learning datasets by separating data storage from header storage. In some implementations, the storage and version control system 102 can be a server, a cloud-based platform, a distributed computing environment, or a combination of physical and virtual computing resources that execute dataset versioning operations. For example, the storage and version control system 102 can be a cloud-hosted service that receives commit requests from remote clients, generates delta-encoded block 113a and delta-encoded block 113b entries in response to those requests, and stores updated header file 121a and header file 121b entries in the header storage layer 120 to record new dataset versions. The storage and version control system 102 can store dataset information in the data storage layer 110 in a columnar format comprising a plurality of columns, each column corresponding to a chain of data blocks comprising at least one full-data block 112 and at least one delta-encoded block 113a and/or delta-encoded block 113b. The storage and version control system 102 can generate delta-encoded block 113a and delta-encoded block 113b entries in response to commit requests and reconstruct dataset versions by processing delta operations relative to full-data block 112 entries. In some implementations, the storage and version control system 102 can coordinate interactions between the data storage layer 110, the header storage layer 120, and the version control layer 130 to maintain dataset versioning functionality, where the version control layer 130 receives instructions from the command line interface 140 and/or the access libraries 150 to create new dataset versions, reconstruct historical dataset versions, migrate main-head blocks, and/or merge branches.

The storage and version control system 102 can include at least one processing resource 104. The at least one processing resource 104 can be one or more processors, central processing units (CPUs), graphics processing units (GPUs), or other computational units that execute instructions stored in the computer-readable medium 106. In some implementations, the at least one processing resource 104 can be a multi-core processor, a distributed processing cluster, or a collection of processing units that perform dataset storage operations, version control operations, and reconstruction operations in parallel or in sequence. For example, the at least one processing resource 104 can execute instructions to store dataset information in the data storage layer 110, generate delta-encoded block 113a and/or delta-encoded block 113b entries in the chain of data blocks, create header file 121a and/or header file 121b entries in the header storage layer 120, and reconstruct dataset versions in response to queries or programmatic requests received from the command line interface 140 and/or the access libraries 150. In some implementations, the at least one processing resource 104 can execute instructions to monitor usage metrics for dataset versions and trigger migration of main-head blocks when usage metrics satisfy threshold conditions, such as when the number of accesses to a dataset version exceeds a threshold number or when the delta chain length from a current main-head block exceeds a threshold length. The at least one processing resource 104 can retrieve instructions from the computer-readable medium 106, decode the instructions, and perform operations on data stored in the data storage layer 110 and the header storage layer 120. The operations can include reading column data 111, executing delta operations from delta-encoded block 113a and/or delta-encoded block 113b entries, writing new data blocks to the data storage layer 110, and updating header file 121a and/or header file 121b entries in the header storage layer 120 to reflect new dataset versions.

The storage and version control system 102 can include a computer-readable medium 106. The computer-readable medium 106 can be a non-transitory storage medium that stores instructions and data for implementing hybrid version control of machine learning datasets. In some implementations, the computer-readable medium 106 can be solid-state drives, hard disk drives, random access memory, or a combination of persistent and volatile storage media that maintain dataset information and versioning metadata. The computer-readable medium 106 can store instructions that, when executed by the at least one processing resource 104, cause the storage and version control system 102 to store dataset information in a columnar format, maintain version metadata, generate delta-encoded block 113a and/or delta-encoded block 113b entries, and reconstruct dataset versions. In some implementations, the computer-readable medium 106 can store instructions to implement lazy loading techniques that load only columns and rows needed for requested operations to minimize memory usage. For example, the computer-readable medium 106 can store instructions that, when executed by the at least one processing resource 104, cause the storage and version control system 102 to identify a subset of columns specified in a query and retrieve only the column data 111 chains corresponding to that subset, without loading column data 111 chains for columns not referenced in the query. The computer-readable medium 106 can place stored data into the data storage layer 110, the header storage layer 120, and the version control layer 130 to separate data content from versioning metadata. The separation can facilitate independent versioning of schema information through header file 121a and header file 121b entries and data content through column data 111 chains to reduce storage overhead and reconstruction latency.

The computer-readable medium 106 can include a data storage layer 110. The data storage layer 110 can be a logical or physical storage arrangement that organizes dataset information in a columnar format where each column corresponds to a separate chain of data blocks. For example, the data storage layer 110 can be a directory structure, a database, or a file system arrangement that maintains separate files or records for full-data block 112 and delta-encoded block 113a and/or delta-encoded block 113b entries for each column in a dataset. The data storage layer 110 can store dataset information in a columnar format comprising a plurality of columns, each column corresponding to a chain of data blocks comprising at least one full-data block 112 and at least one delta-encoded block 113a and/or delta-encoded block 113b, the at least one delta-encoded block 113a and/or delta-encoded block 113b comprising operations to modify a preceding block. In some implementations, the data storage layer 110 can maintain main-head blocks for columns, where the main-head blocks contain full encodings of column data and can be reference points for reconstructing multiple dataset versions. For example, a main-head block can correspond to the full-data block 112 for a given column, such that reconstruction of any dataset version proceeds by processing delta-encoded block 113a and/or delta-encoded block 113b entries relative to that full-data block 112. The data storage layer 110 can implement forward delta encoding for commits ahead of a current head, standard encoding for main-head blocks, and reverse delta encoding for commits behind the current head. For example, commits representing proposed changes or branches can be stored as forward delta blocks that extend from a current head checkpoint, while commits representing historical versions can be stored as reverse delta blocks that describe transformations relative to the main-head block, such that the data storage layer 110 can facilitate efficient access to current heads, navigation to nearby version checkpoints, and compact storage of historical versions.

The data storage layer 110 can include column data 111. The column data 111 can be a chain of data blocks that stores values for a particular column across multiple dataset versions. The column data 111 can include a full-data block 112 containing complete column values and one or more delta-encoded block 113a and/or delta-encoded block 113b entries that describe modifications to the column values. The column data 111 can represent column values for dataset versions by maintaining references between blocks such that delta-encoded block 113a and/or delta-encoded block 113b entries specify operations to modify preceding blocks in the chain. In some implementations, the column data 111 can store blocks in different formats depending on deployment requirements, such that uncompressed formats can be used for memory-mapped access and compressed formats can be used for reduced file size. For example, the column data 111 can store a full-data block 112 in an uncompressed format such as Arrow IPC in a storage environment associated with an inference server, where the full-data block 112 can be memory-mapped from disk for datasets that exceed available computer memory, and can store a corresponding full-data block 112 in a compressed format such as Parquet in a storage environment associated with a repository server to reduce file size. In some implementations, the compressed format for full-data block 112 and/or delta-encoded block 113a and/or delta-encoded block 113b entries can use any suitable compression or encoding scheme, such as run-length encoding, dictionary encoding, bit packing, Snappy, LZ4, Zstandard, and formats such as Parquet, ORC, or Avro-based encodings, among others, selected according to deployment requirements. The column data 111 can include block headers that specify block type, references to previous or next blocks, and block metadata including size and compression type. The block headers can facilitate traversal of the chain of data blocks and selection of appropriate decompression or reconstruction operations when accessing column data 111 for a particular dataset version.

The column data 111 can include a full-data block 112. The full-data block 112 can be a data block that stores complete column values for a dataset version without requiring reconstruction from other blocks. The full-data block 112 can store complete column data in a configured format such that the data can be accessed directly without processing delta operations from other blocks. In some implementations, the full-data block 112 can be encoded in a compressed storage format in a first storage environment associated with a repository server, and a corresponding full-data block 112 can be encoded in a second storage format optimized for memory-mapped access in a second storage environment associated with an inference server. For example, the full-data block 112 can be stored in a compressed format such as Parquet in the first storage environment to reduce file size, and a corresponding full-data block 112 can be stored in an uncompressed format such as Arrow IPC in the second storage environment so that column values can be memory-mapped from disk for datasets that exceed available computer memory. The full-data block 112 can be a main-head block that contains a full encoding of column data and can be a reference block for reconstructing data for a plurality of dataset versions. The reference block can be selected such that reconstruction operations for multiple dataset versions can process delta-encoded block 113a and/or delta-encoded block 113b entries relative to the main-head block without requiring traversal of the entire version history.

The column data 111 can include a delta-encoded block 113a/113b. The delta-encoded block 113a can be a data block that stores operations to modify a preceding block in the chain of data blocks for a column. The operations can include at least one of keep operations, delete operations, update operations, and/or insert operations that describe changes to column values relative to a previous dataset version. In some implementations, the delta-encoded block 113a/113b can be a forward delta block that represents changes ahead of a current head, or a reverse delta block that represents changes behind the current head. For example, a forward delta delta-encoded block 113a/113b can store operations such as “Keep 3” and “Insert: 3423” that describe how to transform column values at the head checkpoint to obtain column values for a proposed change or branch, while a reverse delta delta-encoded block 113a/113b can store operations such as “Delete 2” that describe how to transform column values from a more recent block to obtain column values for a prior dataset version. The delta-encoded block 113a/113b can store operations in a compressed format to reduce storage requirements while maintaining the ability to reconstruct column values for dataset versions. The compressed format can use standard compression libraries selected according to the configured storage format, such that delta operations and associated data can be decompressed during reconstruction operations.

In some implementations, the delta-encoded block 113a/113b can represent a branch in the version history where changes are made independently from other branches, such that the delta-encoded block 113a/113b extends from a common ancestor block without modifying the primary version history. For example, a branching delta-encoded block 113a/113b can store a forward delta that describes proposed modifications to column values at the head checkpoint, while the primary sequence of delta-encoded blocks in the chain remains unchanged. The delta-encoded block 113a/113b can include a block header that specifies a reference to a previous block, such that the chain of data blocks can be traversed during reconstruction operations. For example, the block header can store a hash value or file path identifier that uniquely locates the delta-encoded block 113a or the full-data block 112 that precedes the delta-encoded block 113b in the chain, the storage and version control system 102 can determine the sequence of operations to execute when reconstructing column values for a particular dataset version.

The computer-readable medium 106 can include a header storage layer 120. The header storage layer 120 can be a logical or physical storage arrangement that maintains version metadata through content-addressable header files that map columns to head blocks in chains of data blocks. In some implementations, the header storage layer 120 can be a directory structure or database that stores header file 121a and header file 121b entries where each header file can be referenced by its hash value and contains metadata for a particular dataset version. For example, the header storage layer 120 can store a header file 121a entry with an evaluation function reference as a hash of associated evaluation code, dataset metadata as key-value properties, and per-column metadata including column name, datatype, nullability, and head identifiers that point to specific blocks in chains of data blocks for each column. The header storage layer 120 can store version metadata comprising a plurality of content-addressable header file 121a and header file 121b entries, at least one header file representing a dataset version and comprising column metadata mapping at least one column to a head block in the chain of data blocks. The header storage layer 120 can use hash-indexed pointers and content-addressable references such that header file 121a and header file 121b entries can be accessed by their hash values to facilitate version control functionality. In some implementations, the header storage layer 120 can store header file 121a and header file 121b entries independently from column data 111 such that schema changes can be versioned without regenerating all column data 111 and data changes can be versioned without regenerating header files when column structure remains unchanged.

The header storage layer 120 can include a header file 121a. The header file 121a can be a content-addressable file that represents a dataset version and contains metadata for loading the dataset. The header file 121a can represent a dataset version and include column metadata mapping at least one column to a head block in a chain of data blocks for the column. In some implementations, the header file 121a can be stored with a filename derived from its hash value and can contain an evaluation function reference as a hash of associated evaluation code, dataset properties as key-value pairs, and per-column metadata that specifies head blocks in chains of data blocks. For example, the header file 121a can store per-column metadata for a column named “input_text” by recording the column name, a datatype such as utf8, a nullability flag, and a head identifier that points to a block in the column data 111 chain corresponding to the dataset version represented by the header file 121a. In some implementations, the header file 121a can point to a delta-encoded block 113a or a delta-encoded block 113b and need not point to the full-data block 112 directly, such that the version can be reconstructed by traversing delta operations from the head block identified by the head identifier through the chain of data blocks to the full-data block 112. For example, the head identifier in the header file 121a can reference a delta-encoded block 113a positioned between the full-data block 112 and a proposed change, requiring the version control layer 130 to determine the sequence of delta operations between that delta-encoded block 113a and the full-data block 112 to reconstruct the column data 111 for the dataset version represented by the header file 121a.

The header storage layer 120 can include a header file 121b. The header file 121b can be a content-addressable file that represents a dataset version distinct from the dataset version represented by the header file 121a and contains metadata for loading that dataset version. In some implementations, the header file 121b can represent a new dataset version created in response to a commit request comprising changes relative to a prior dataset version, where the header file 121b contains column metadata mapping at least one column to a head block in the chain of data blocks. For example, the header file 121b can be a file representing a subsequent commit relative to the dataset version represented by the header file 121a, where the header file 121b contains updated column metadata that points to different head blocks in chains of data blocks for columns that were modified during the commit while retaining the same head block identifiers as the header file 121a for columns that were not modified. In some implementations, the header file 121b can be associated with branch metadata identifying a branch name and a parent dataset version to facilitate branching and merging operations, such that the version control layer 130 can maintain a directed acyclic graph of dataset versions where each of the header file 121a and the header file 121b can be recorded with references to parent header files to track version history. For example, the header file 121b can store a branch name and a reference to the header file 121a as its parent dataset version, the version control layer 130 can traverse the directed acyclic graph to determine the sequence of commits between any two dataset versions. The header file 121b can be stored using a hash value derived from its content such that the header file 121b can be accessed uniquely and retrieved by the version control layer 130 when reconstructing a dataset version corresponding to that hash value.

The computer-readable medium 106 can include a version control layer 130. The version control layer 130 can be a set of instructions or logic that coordinates operations between the data storage layer 110 and the header storage layer 120 to provide version control functionality for machine learning datasets. For example, the version control layer 130 can implement version control operations such as creating new dataset versions, reconstructing historical dataset versions, migrating main-head blocks, and merging branches, among others. The version control layer 130 can generate, in response to a commit request comprising changes relative to a prior dataset version, at least one new delta-encoded block 113a and/or delta-encoded block 113b in the chain of data blocks for at least one column identified as modified and a new header file representing a new dataset version. In some implementations, the version control layer 130 can reconstruct data for at least one column for a requested dataset version by identifying a header file 121a and/or header file 121b corresponding to the requested dataset version and processing delta-encoded block 113a and/or delta-encoded block 113b entries in the chain of data blocks relative to a full-data block 112. For example, the version control layer 130 can receive a dataset version identifier corresponding to a header file 121a or header file 121b, retrieve the corresponding header file from the header storage layer 120, and traverse the chain of data blocks for each column by starting at the head block identified in the header file and executing delta operations from delta-encoded block 113a and/or delta-encoded block 113b entries relative to the full-data block 112 to obtain the reconstructed column values.

In some implementations, the version control layer 130 can maintain auxiliary index metadata that associates dataset version identifiers with precomputed information such as the distance in delta blocks between a head block and a main-head data block, where such index metadata can be provided to the version control layer 130 to select efficient reconstruction paths or to determine when migrating the main-head data block would reduce the number of delta-encoded block 113a and/or delta-encoded block 113b entries processed during reconstruction. For example, the version control layer 130 can read the precomputed delta-block distance stored in the auxiliary index metadata for a requested dataset version and compare that distance against a threshold chain length to determine whether to initiate migration of the main-head data block before traversing the chain of data blocks to reconstruct the column values. The version control layer 130 can determine which columns were modified by comparing local data with reconstructed data for the prior dataset version, generate delta encodings for each changed column, create a new header file 121b with updated column references pointing to newly generated delta-encoded block 113a and/or delta-encoded block 113b entries, and add metadata about the checkpoint to a version log. The metadata can include a timestamp, author, commit message, and references to parent dataset versions to maintain a complete version history in the header storage layer 120.

The computer-readable medium 106 can include a command line interface 140. The command line interface 140 can be a set of instructions or logic that provides text-based commands for interacting with the storage and version control system 102 to perform version control operations on machine learning datasets. In some implementations, the command line interface 140 can accept commands such as checkout, commit, log, diff, branch, merge, pull, and/or push to perform version control operations on datasets stored in the data storage layer 110 and the header storage layer 120. For example, a checkout command can extract a specific version of a dataset into formats such as CSV, JSON, or Parquet. A commit command can detect local changes, generate delta-encoded block 113a and/or delta-encoded block 113b entries for modified columns, and create a new header file 121a or header file 121b representing a new dataset version. A log command can display version history with associated metadata, a diff command can present differences between two dataset versions. A branch command can establish an alternative sequence of header file 121a and/or header file 121b entries for independent modifications. A merge command can combine changes from different branches into a merged dataset version. A pull command can copy new data from a central repository to a local repository so that all changes are present locally. A push command can copy new data from the local repository to the central repository so that all changes are stored centrally.

In some implementations, the command line interface 140 can transmit instructions to the version control layer 130 to perform commit operations that do not move the head file for the column data 111, such that migration of the main-head block in the data storage layer 110 can be deferred and performed on major changes rather than on each commit. In some implementations, the command line interface 140 can invoke operations to move the main-head to a chosen head in the column data 111 chain, such that the version control layer 130 generates a new full-data block 112 at the target location and updates the header storage layer 120 to record the new main-head block. For example, the command line interface 140 can expose a command that accepts a head identifier corresponding to a delta-encoded block 113a or delta-encoded block 113b in the chain, and transmit that identifier to the version control layer 130 to initiate main-head migration, reducing the number of delta operations the version control layer 130 executes during subsequent reconstruction of frequently accessed dataset versions.

The computer-readable medium 106 can include access libraries 150. The access libraries 150 can be a set of programmatic interfaces that provide functions for loading dataset data and performing version control operations through code rather than command line inputs. The access libraries 150 can read dataset versions with efficient loading of only required columns, write and append new data to existing datasets, create and manage dataset schemas, navigate version history and access previous dataset states, and generate and apply diffs between versions. In some implementations, the access libraries 150 can implement lazy loading techniques that minimize memory requirements by loading only the columns and rows needed for a requested operation. For example, the access libraries 150 can receive a programmatic request specifying a subset of columns for a particular dataset version and retrieve only the column data 111 chains corresponding to that subset from the data storage layer 110, without loading column data 111 chains for columns not referenced in the request, such that memory usage can be reduced when the full dataset is not required. The access libraries 150 can expose methods for moving the main-head to a chosen head in a column data 111 chain, such that applications using the access libraries 150 can trigger main-head migration operations by supplying a head identifier corresponding to a target block in the chain. In some implementations, the access libraries 150 can detect that a central migration to the main-head occurred on a central repository and perform a corresponding local migration to align the local dataset state with the central dataset state. For example, the access libraries 150 can query the central repository for the current main-head identifier, compare it against the locally recorded main-head identifier, and invoke the version control layer 130 to generate a new full-data block 112 at the target location and update the header storage layer 120 to record the new main-head block when the identifiers differ.

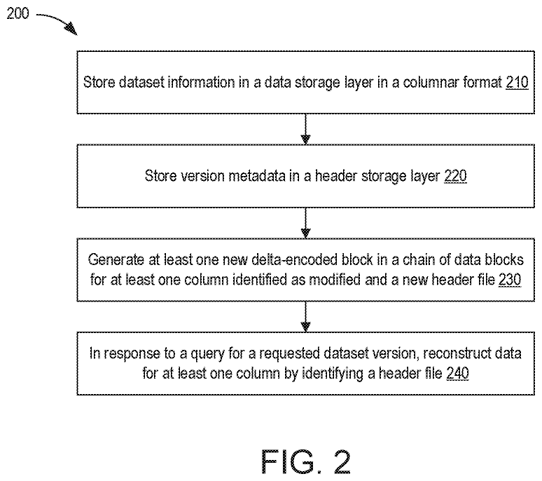

Referring now to FIG. 2, illustrated is a flow chart of a method 200 for efficient storage and version control of machine learning datasets. The method 200 can be executed, performed, or otherwise carried out by any of the computing systems or devices described herein. In brief overview of the method 200, the method 200 can include store dataset information 210, store version metadata 220, generate new delta-encoded block and new header file 230, and reconstruct data 240.

The method 200 can include store dataset information 210. The storage and version control system 102 can store dataset information in the data storage layer 110 in a columnar format comprising a plurality of columns, each column corresponding to a chain of data blocks comprising at least one full-data block 112 and at least one delta-encoded block 113a and/or delta-encoded block 113b. In some implementations, the storage and version control system 102 can store dataset information upon receiving a command from the command line interface 140 or a programmatic call from the access libraries 150 to create a new dataset. For example, the command line interface 140 can receive a user-issued command specifying a dataset name and schema, and transmit a creation request to the version control layer 130, which instructs the data storage layer 110 to allocate a separate chain of data blocks for each column declared in the schema.

The storage and version control system 102 can store dataset information by writing column values to the data storage layer 110 and associating each column with a chain identifier that references the corresponding chain of data blocks. Each full-data block 112 and each delta-encoded block 113a and/or delta-encoded block 113b in the chain can include a block header that specifies block type, a reference to a previous or next block, and block metadata including size and compression type. In some implementations, the storage and version control system 102 can store dataset information when initializing a new dataset or when creating a first version of a dataset to be version-controlled, such that the initial chain for each column contains a single full-data block 112 with no preceding delta-encoded block 113a or delta-encoded block 113b entries. For example, the data storage layer 110 can store the initial full-data block 112 for a column named “input_text” by writing all column values to a file identified by a generated key, and recording the block type as full data, a null reference for the previous block, and block metadata specifying the file size and compression type in the block header.

The storage and version control system 102 can store full-data block 112 entries in different storage formats depending on deployment requirements. In some implementations, the storage and version control system 102 can store a full-data block 112 in an uncompressed format such as Arrow IPC in a storage environment associated with an inference server, such that column values can be memory-mapped from disk for datasets that exceed available computer memory. For example, a full-data block 112 for a column containing numerical arrays can be stored in Arrow IPC format in the inference server environment so that the access libraries 150 can access column values at specific offsets without loading the full full-data block 112 into memory. In some implementations, the storage and version control system 102 can store a corresponding full-data block 112 for the same column in a compressed format such as Parquet in a storage environment associated with a repository server to reduce file size, such that the two storage environments maintain the same column data in formats suited to their respective access patterns.

The method 200 can include store version metadata 220. The storage and version control system 102 can store version metadata in the header storage layer 120, the version metadata comprising a plurality of content-addressable header file 121a and/or header file 121b entries, at least one header file representing a dataset version and comprising column metadata mapping at least one column to a head block in the chain of data blocks for that column. In some implementations, the storage and version control system 102 can store version metadata immediately after storing dataset information in the data storage layer 110 to establish the first dataset version, such that the initial header file 121a entry points to the full-data block 112 for each column in the dataset. For example, the storage and version control system 102 can create a header file 121a entry that includes an evaluation function reference as a hash of associated evaluation code, metadata as key-value properties, and per-column metadata including a column name, a column datatype, a column nullability, and a head identifier that points to a specific block in the chain of data blocks for each column.

The storage and version control system 102 can store version metadata after generating at least one delta-encoded block 113a and/or delta-encoded block 113b to create a subsequent dataset version, such that the new header file 121b entry reflects updated column head identifiers for columns that were modified during the commit operation while retaining existing head identifiers for columns that were not modified. In some implementations, the storage and version control system 102 can store version metadata by computing a hash value of the header file 121a and/or header file 121b content, using the hash value as a filename or identifier for the header file, and writing the header file to the header storage layer 120 such that the header file can be accessed by its hash value. For example, the storage and version control system 102 can receive a commit request that modifies a column identified by a first column name while leaving a column identified by a second column name unchanged, generate a new delta-encoded block 113a for the modified column, create a new header file 121b entry in which a first column head points to the new delta-encoded block 113a and a second column head retains the same identifier as in the prior header file 121a entry, and write the new header file 121b to the header storage layer 120 using the hash of its content as its identifier.

The storage and version control system 102 can store version metadata for nested column structures by recording per-column metadata for both parent columns and child columns in a header file 121a and/or header file 121b entry, including a parent column name, a parent column datatype, a parent column nullability, a parent column head, and corresponding metadata for child columns such as child column name, child column datatype, child column nullability, and child column head. In some implementations, the storage and version control system 102 can store version metadata for a dataset version in which the parent column head and the child column heads point to separate chains of data blocks, such that modifications to child columns can be tracked independently from modifications to the parent column while the header storage layer 120 preserves the parent-child relationships defined in the schema. For example, the storage and version control system 102 can generate a new header file 121b entry in which the parent column head retains the same identifier as in the prior header file 121a entry while the first child column head points to a newly generated delta-encoded block 113a reflecting a modification to the first child column, and the second child column head retains its prior identifier, such that the version control layer 130 can reconstruct the nested data structure by retrieving data from the blocks identified by the parent column head, the first child column head, and the second child column head and combining them according to the parent-child relationships recorded in the header storage layer 120.

The method 200 can include generate new delta-encoded block and new header file 230. The storage and version control system 102 can generate, in response to a commit request comprising changes relative to a prior dataset version, at least one new delta-encoded block 113a and/or delta-encoded block 113b in the chain of data blocks for at least one column identified as modified and a new header file 121a or header file 121b representing a new dataset version, the new header file comprising column metadata mapping the at least one column to a head block in the chain of data blocks. In some implementations, the storage and version control system 102 can generate the new delta-encoded block 113a and/or delta-encoded block 113b and the new header file 121a or header file 121b in response to receiving a commit request from the command line interface 140 or a programmatic call from the access libraries 150. For example, the command line interface 140 can receive a user-issued commit command, transmit the commit request to the version control layer 130, which in turn reconstructs column data 111 for the prior dataset version by retrieving the corresponding header file 121a from the header storage layer 120, compares the reconstructed column data 111 against locally modified data for each column, and identifies a subset of columns for which differences exist.

The storage and version control system 102 can generate the new delta-encoded block 113a and/or delta-encoded block 113b by determining modifications for each column in the identified subset and encoding those modifications as delta operations stored in the data storage layer 110 with references to preceding blocks in the chain of data blocks. For each column in the identified subset, the version control layer 130 can generate a delta-encoded block 113a and/or delta-encoded block 113b containing keep operations, delete operations, update operations, and/or insert operations that collectively describe the transformation from the prior dataset version to the new dataset version. In some implementations, the version control layer 130 can store each newly generated delta-encoded block 113a and/or delta-encoded block 113b in the data storage layer 110 under a generated key, with a block header that specifies the block type as delta, a reference to the preceding block in the chain, and block metadata including size and compression type. For example, for a column in which two rows were appended and three rows were retained unchanged, the version control layer 130 can generate a delta-encoded block 113a containing a keep operation specifying an offset of zero and a count of three, followed by an insert operation containing the two new row values encoded in a compressed format, and store the block with a reference to the prior head block identified in the preceding header file 121a.

The storage and version control system 102 can generate the new header file 121b by creating column metadata that maps each column to a head block, where the head block can be a newly generated delta-encoded block 113a and/or delta-encoded block 113b for columns in the modified subset or an existing block for columns not in the modified subset. In some implementations, the version control layer 130 can add version log metadata to the new header file 121b including a timestamp, an author identifier, and a reference to the prior header file 121a as a parent dataset version, such that the header storage layer 120 maintains a directed acyclic graph of dataset versions across successive commits. For example, if a commit modifies the column identified by a first column name while leaving the column identified by a second column name unchanged, the version control layer 130 can generate a new header file 121b in which a first column head references the newly generated delta-encoded block 113a and a second column head retains the same block identifier as the preceding header file 121a, then compute a hash of the new header file 121b content and store the new header file 121b in the header storage layer 120 using that hash as its identifier.

The method 200 can include reconstruct data 240. The storage and version control system 102 can, in response to a query for a requested dataset version, reconstruct data for at least one column for a requested dataset version by identifying a header file corresponding to the requested dataset version and processing delta-encoded block 113a and/or delta-encoded block 113b entries in the chain of data blocks for the at least one column relative to a full-data block 112. In some implementations, the storage and version control system 102 can reconstruct data when receiving a query from the command line interface 140 for a checkout operation or when receiving a programmatic request from the access libraries 150 to load a specific dataset version. For example, the command line interface 140 can receive a user-issued checkout command specifying a dataset version identifier or a hash of a header file 121a or header file 121b, transmit the query to the version control layer 130, which retrieves the corresponding header file from the header storage layer 120, extracts column metadata to identify head blocks for each column, and traverses the chain of data blocks from each head block to the full-data block 112 to reconstruct the complete column values for the requested dataset version. The version control layer 130 can determine the sequence of delta-encoded block 113a and/or delta-encoded block 113b entries between the identified head block and the full-data block 112 by following block header references in each block, such that the reconstruction path can span forward delta blocks, reverse delta blocks, or both depending on the position of the head block relative to the main-head data block in the column data chain.

The storage and version control system 102 can reconstruct data by identifying a main-head data block in the column data chain that contains a full encoding of the column, selecting the main-head data block as a reference block for reconstructing data for the requested dataset version, and processing delta-encoded block 113a and/or delta-encoded block 113b entries in the column data chain relative to the main-head data block to obtain reconstructed data. The version control layer 130 can execute reconstruction operations by reading the main-head data block to obtain initial column values, traversing the column data chain to identify delta-encoded block 113a and/or delta-encoded block 113b entries positioned between the main-head data block and the head block for the requested dataset version, and sequentially executing delta operations to produce the final reconstructed column data. For example, the version control layer 130 can execute a keep operation that copies a specified range of rows by offset and count from a prior state, a delete operation that removes a specified range of rows, an update operation that decodes replacement data values encoded in a compressed format and overwrites corresponding values obtained from the full-data block 112 or a prior delta-encoded block 113a or delta-encoded block 113b, and an insert operation that decodes insert data values and places those values at one or more specified locations within the column, to produce the complete column values for the requested dataset version. In some implementations, the version control layer 130 can execute reverse delta operations when the requested dataset version corresponds to a block positioned in the historical direction from the main-head data block, and forward delta operations when the requested dataset version corresponds to a block positioned in the proposed-change direction from the main-head data block such as the branch block.

In some implementations, the storage and version control system 102 can reconstruct data after receiving a query that specifies a subset of columns for the requested dataset version, such that the version control layer 130 retrieves column metadata from the header file 121a or header file 121b corresponding to the requested dataset version for the subset of columns and reconstructs data for the subset of columns by processing delta-encoded block 113a and/or delta-encoded block 113b entries in the chains of data blocks corresponding to the subset of columns. For example, the access libraries 150 can receive a programmatic request specifying a dataset version identifier and a list of column names such as the column identified by a first column name and the column identified by a second column name, and the version control layer 130 can retrieve head block identifiers from a first column head and a second column head in the corresponding header file 121a or header file 121b and process only the column data chain entries associated with those columns, without traversing chains of data blocks for columns not specified in the request. The access libraries 150 can transmit the reconstructed column data for the subset of columns to the requesting application without loading column data 111 chains for unspecified columns, such that memory requirements can be reduced when the full dataset is not required for the requested operation.

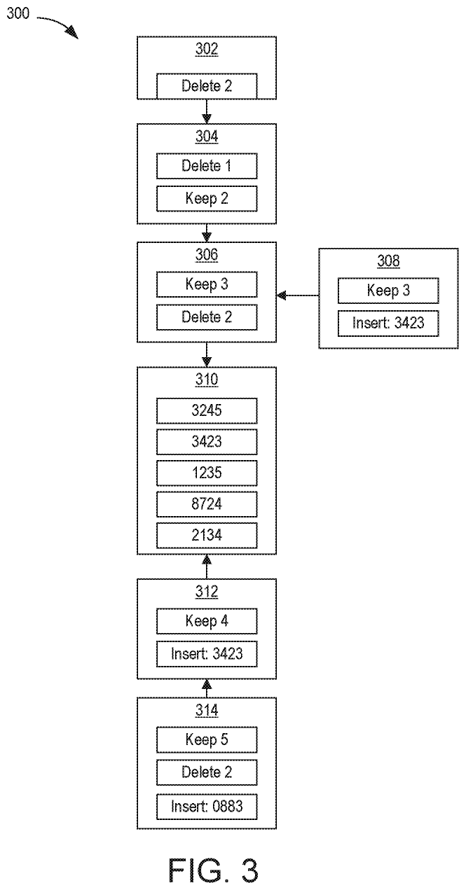

Referring now to FIG. 3, illustrated is a block diagram of a column data chain 300 including a main-head data block 310, reverse delta block 302 and reverse delta block 304 positioned in the historical direction from the main-head data block 310, forward delta block 312 and forward delta block 314 positioned in the proposed-change direction from the main-head data block 310, a head block 306 identifying a current dataset version checkpoint, and a branch block 308 extending from the head block 306 as a common ancestor. The column data chain 300 can include the main-head data block 310, the reverse delta block 302, the reverse delta block 304, the head block 306, the branch block 308, the forward delta block 312, and the forward delta block 314.

The column data chain 300 can be a linked structure of data blocks that represents the version history of a single column through a combination of full-data blocks and delta-encoded blocks, where each block contains either complete column data or operations that modify preceding blocks, and blocks reference one another through pointers or identifiers to form a traversable chain. The column data chain 300 can implement a hybrid versioning arrangement for column data in which commits ahead of a current head use forward delta encoding, a main-head uses standard encoding, and commits behind the current head use reverse delta encoding. In some implementations, the column data chain 300 can represent multiple branches where different sequences of delta blocks extend from a common ancestor block to capture independent changes to the column. For example, a branch can be formed by establishing a new sequence of forward delta blocks that originate from the head block 306, such that the branched sequence records proposed modifications independently from the primary version history without altering the blocks already present in the column data chain 300. The column data chain 300 can place blocks such that the main-head data block 310 can be a reference point for reconstructing dataset versions, with reverse delta blocks 302, 304, 312, and 314 storing operations that describe historical changes relative to the main-head data block 310 and the branch block 308 storing operations that describe proposed changes or branch modifications. The column data chain 300 can facilitate reconstruction of a requested dataset version by identifying the head block 306 from a header file, determining the position of the head block 306 relative to the main-head data block 310, and traversing the column data chain 300 to execute delta operations in the correct direction to obtain the reconstructed column data.

The column data chain 300 can include one or more reverse delta blocks, including a reverse delta block 302 and a reverse delta block 304. Each of the reverse delta block 302 and the reverse delta block 304 can be a delta-encoded block that stores operations to reconstruct a prior dataset version by executing modifications in reverse relative to a more recent block in the column data chain 300. In some implementations, the reverse delta block 302 and the reverse delta block 304 can be positioned in the column data chain 300 such that traversal from the main-head data block 310 toward older dataset versions proceeds through each in sequence to reconstruct historical dataset versions. For example, the reverse delta block 302 can be a file or record in which a block header specifies a block type of delta, a reference to a preceding block in the column data chain 300, and block metadata including file size and compression type, while a data section stores keep operations that reference rows by offset and count, delete operations that specify row ranges to be removed, update operations that include replacement data values encoded in a compressed format, and insert operations that include data values to be placed at specified locations within the column, and the reverse delta block 304 can be a file or record with the same structure that follows the reverse delta block 302 in the historical direction and stores a delete operation specifying one row to be removed and a keep operation specifying a count of two rows to be retained.

The version control layer 130 can execute the operations from the reverse delta block 302 and subsequently the operations from the reverse delta block 304 to column values obtained from the main-head data block 310 to reconstruct the column data for successively earlier dataset versions. The reverse delta block 304 can include a block header that specifies a reference to the preceding reverse delta block 302, such that the column data chain 300 can be traversed to reconstruct any historical version by following references from newer blocks to older blocks. The compressed format used in the reverse delta block 302 and the reverse delta block 304 can reduce storage requirements for historical dataset versions by encoding only the differences between versions rather than storing complete column data for each version.

The column data chain 300 can include a head block 306. The head block 306 can be a block identifier stored in a header file that points to a specific block in the column data chain 300, where the identified block can be a full-data block 112, a reverse delta block such as reverse delta block 302 or reverse delta block 304, or a branch block 308, depending on the dataset version being represented. The head block 306 can be the starting point for reconstructing column data for a requested dataset version by identifying which block in the column data chain 300 corresponds to that version. In some implementations, the head block 306 can point to a delta-encoded block 113a and need not point to the main-head data block 310, such that reconstruction proceeds by determining the path from the head block 306 to the main-head data block 310 and executing delta operations along that path. For example, the head block 306 can reference a reverse delta block 302 positioned between the main-head data block 310 and an older historical version, requiring the version control layer 130 to traverse from the head block 306 through intermediate delta-encoded block 113a and/or delta-encoded block 113b entries to the main-head data block 310 and execute the delta operations in sequence to obtain the reconstructed column values for the requested dataset version. The head block 306 can be selected by the header storage layer 120 when creating a new header file for a dataset version, where the selection depends on which columns were modified during the commit operation that created the new version. In some implementations, the header storage layer 120 can reuse existing block identifiers as the head block 306 for columns that were not modified while assigning new block identifiers for columns that received newly generated delta-encoded block 113a and/or delta-encoded block 113b entries, such that header files for different versions can point to different head block 306 positions in the same column data chain 300 without duplicating unchanged column data.

The column data chain 300 can include a branch block 308. The branch block 308 can be a delta-encoded block that stores operations to reconstruct a branched dataset version by applying modifications in a forward direction relative to the head block 306 as a common ancestor. In some implementations, the branch block 308 can represent a version history path that diverges independently from the primary sequence of delta-encoded blocks in the column data chain 300, such that the branch block 308 extends from the head block 306 without altering any block already present in the primary chain. For example, the branch block 308 can be a file or record that contains operations such as “Keep 3” and “Insert: 3423” that describe how to transform column values at the head block 306 to obtain column values for an independently developed branch version, where a keep operation retains three rows by offset and count from the head block 306 and an insert operation appends the value “3423” at a specified location. The branch block 308 can store delta operations in a compressed format such that only the differences between the column values at the head block 306 and the branched version are encoded, without duplicating the column data present in the main-head data block 310 or other blocks in the primary chain. The version control layer 130 can reconstruct the branched dataset version by retrieving the column values from the main-head data block 310, traversing the column data chain 300 to the head block 306, and executing the delta operations stored in the branch block 308 to obtain the final column values for the branch. In some implementations, the branch block 308 can serve as the starting point for additional forward delta blocks that extend the branch with further independent changes, such that the column data chain 300 can facilitate multiple concurrent branches originating from the head block 306 as a shared common ancestor without modifying the primary version history.

The column data chain 300 can include a main-head data block 310. The main-head data block 310 can be a full-data block that contains a complete encoding of column values and can be a reference point for reconstructing multiple dataset versions. In some implementations, the main-head data block 310 can be a file or record that stores all values for the column, such as the values “3245”, “3423”, “1235”, “8724”, and “2134”, in a configured format such as Arrow IPC or Parquet, without requiring reconstruction from other blocks. The main-head data block 310 can be selected as a reference block for reconstructing data for a plurality of dataset versions for the column, such that reconstruction operations for multiple dataset versions can process delta-encoded block 113a and/or delta-encoded block 113b entries relative to the main-head data block 310. In some implementations, the main-head data block 310 can be positioned in the column data chain 300 such that reverse delta block 302 and reverse delta block 304 entries extend in the direction of historical versions and branch block 308 entries extend in the direction of proposed changes or branch modifications. The main-head data block 310 can be migrated to a different block in the column data chain 300 based on usage metrics such as access frequency or delta chain length, such that frequently accessed versions can be reconstructed by processing fewer delta operations.

In some implementations, trigger conditions for migrating the main-head data block 310 can be configured according to deployment requirements. For example, a central repository server can initiate migration when a pull request is merged or when a new semantic version tag is created, such that the main-head data block 310 is repositioned to align with the dataset version that becomes the primary reference point following the merge or version promotion event. In some implementations, an inference server can initiate migration when measured access frequency to a particular dataset version exceeds a threshold, such that the main-head data block 310 is repositioned to the block corresponding to that dataset version to reduce the number of delta operations the version control layer 130 applies during subsequent reconstruction requests. In some implementations, an inference server can initiate migration when the number of delta-encoded block 113a and/or delta-encoded block 113b entries between the main-head data block 310 and a frequently accessed head block 306 exceeds a threshold chain length, such that the version control layer 130 generates a new full-data block 112 at the target location and updates the version metadata in the header storage layer 120 to record the new main-head data block 310.

The column data chain 300 can include one or more forward delta blocks, including a forward delta block 312. The forward delta block 312 can be a delta-encoded block that stores operations to reconstruct a future dataset version by applying modifications in a forward direction relative to the main-head data block 310. In some implementations, the forward delta block 312 can represent a commit ahead of the main-head data block 310 in the column data chain 300, such that reconstruction of the dataset version corresponding to the forward delta block 312 proceeds by reading the full column values from the main-head data block 310 and executing the operations stored in the forward delta block 312 to obtain the column values for the later version. For example, the forward delta block 312 can be a file or record that contains operations such as “Keep 4” and “Insert: 3423” that describe how to transform column values from the main-head data block 310 to obtain column values for a dataset version that adds a new row to a retained set of rows. The forward delta block 312 can include a block header that specifies a block type of delta, a reference to the main-head data block 310 as the preceding block, and block metadata including size and compression type. The operations stored in the forward delta block 312 can include keep operations that retain a specified number of rows by offset and count, delete operations that remove specified row ranges, update operations that include replacement data values encoded in a compressed format, and/or insert operations that place new data values at specified locations within the column, such that the forward delta block 312 can represent arbitrary forward modifications to the column data relative to the main-head data block 310.

The column data chain 300 can include one or more forward delta blocks, including a forward delta block 314. The forward delta block 314 can be a delta-encoded block that stores operations to reconstruct a dataset version further ahead of the main-head data block 310 by applying modifications in a forward direction relative to the forward delta block 312. In some implementations, the forward delta block 314 can be positioned in the column data chain 300 such that reconstruction of the dataset version corresponding to the forward delta block 314 requires traversing from the main-head data block 310 through the forward delta block 312 and then through the forward delta block 314, executing delta operations at each step in sequence. For example, the forward delta block 314 can be a file or record that contains operations such as “Keep 5”, “Delete 2”, and “Insert: 0883” that describe how to transform column values obtained after executing the forward delta block 312 to obtain column values for an even later dataset version, where five rows are retained, two rows are removed, and a new row with the value “0883” is inserted at a specified location. The forward delta block 314 can include a block header that specifies a reference to the preceding forward delta block 312, such that the column data chain 300 can be traversed by following block header references from the main-head data block 310 through intermediate forward delta blocks to reach the forward delta block 314. The version control layer 130 can determine the complete path from the main-head data block 310 to the forward delta block 314 by following references through the forward delta block 312, and can reconstruct the dataset version represented by the forward delta block 314 by executing all delta operations along that path in sequence.

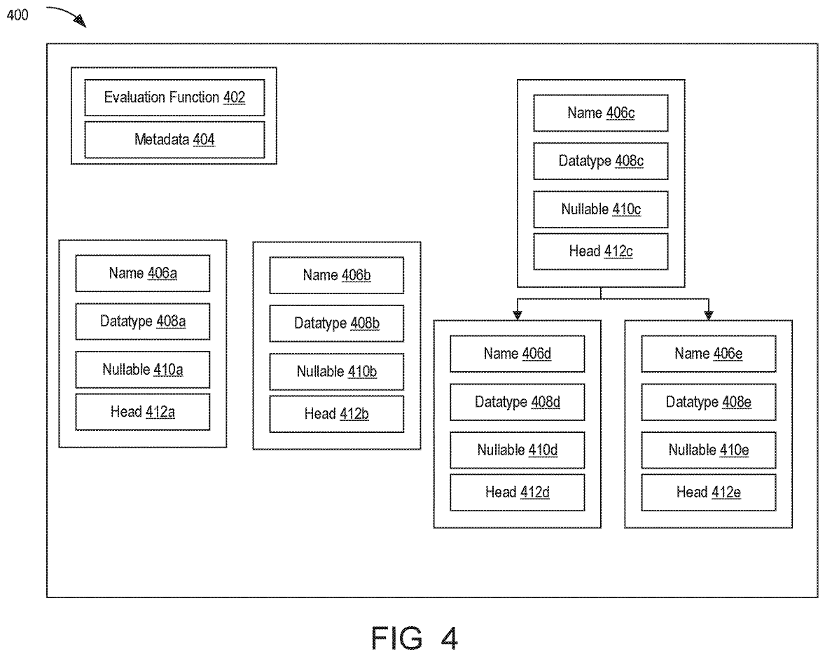

Referring now to FIG. 4, illustrated is a schematic diagram of header storage 400 for a versioned machine learning dataset, according to an embodiment. The header storage 400 can include an evaluation function reference 402, metadata 404, a column name 406a, a column datatype 408a, a column nullability 410a, a column head 412a, a column name 406b, a column datatype 408b, a column nullability 410b, a column head 412b, a parent column name 406c, a parent column datatype 408c, a parent column nullability 410c, a parent column head 412c, a child column name 406d, a child column datatype 408d, a child column nullability 410d, a child column head 412d, a child column name 406e, a child column datatype 408e, a child column nullability 410e, and a child column head 412e.

The header storage 400 can be a logical storage structure that maintains dataset-loading information for versioned machine learning datasets. The header storage 400 can be a content-addressable file stored in the header storage layer 120 that contains the data needed to load a dataset version by specifying evaluation functions, dataset properties, and per-column metadata. In some implementations, the header storage 400 can be referenced by its hash value, such that the version control layer 130 can locate the header storage 400 corresponding to a requested dataset version by supplying the hash value as an identifier. For example, the header storage 400 can store an evaluation function reference 402, metadata 404, and column-specific information for multiple columns including names, datatypes, nullability indicators, and head identifiers that point to blocks in chains of data blocks for each column, with the hash value computed from the full content of the header storage 400 such that two header storage 400 files with identical content produce identical hash values and can be deduplicated in the header storage layer 120. The header storage 400 can provide the data needed to load a dataset version by storing base metadata including the evaluation function reference 402 and metadata 404, and per-column metadata for each column in the dataset. In some implementations, the header storage 400 can store per-column metadata for simple columns such as column name 406a, column datatype 408a, column nullability 410a, and column head 412a, as well as for nested columns that have parent-child relationships such as parent column name 406c, child column name 406d, and child column name 406e. The version control layer 130 can retrieve the header storage 400 by its hash value when reconstructing a dataset version, and can extract per-column metadata from the header storage 400 to determine which blocks in the chains of data blocks in the data storage layer 110 contain the data for that version.

The header storage 400 can include an evaluation function reference 402. The evaluation function reference 402 can be a hash value that identifies evaluation code associated with the dataset version represented by the header storage 400. In some implementations, the evaluation function reference 402 can be computed by applying a hash function to the evaluation code and storing the resulting hash value in the header storage 400 alongside the metadata 404 and per-column metadata to provide a complete specification of the dataset version including both data and evaluation logic. For example, the evaluation function reference 402 can store the hash of evaluation code that is retrievable from a content-addressable repository by supplying the hash value as a lookup identifier, such that the version control layer 130 can locate the evaluation code corresponding to the dataset version by reading the evaluation function reference 402 from the header storage 400 and using the stored hash value to retrieve the evaluation code from the repository. The evaluation function reference 402 can store a reference to evaluation code such that a dataset-loading system can retrieve the corresponding code when loading the dataset version represented by the header storage 400. In some implementations, the evaluation function reference 402 can be stored in the header storage 400 as a field distinct from the metadata 404 key-value pairs, such that the version control layer 130 can read the evaluation function reference 402 independently from the metadata 404 when loading only the evaluation logic for a dataset version without reconstructing column data from the data storage layer 110.

The header storage 400 can include metadata 404. The metadata 404 can be a key-value store for dataset properties that describe characteristics of the dataset version represented by the header storage 400. For example, the metadata 404 can store properties such as dataset name, creation date, author, description, or version number, among others, as key-value pairs such that applications loading the dataset can access and interpret individual properties to understand the dataset context. In some implementations, the metadata 404 can be stored in a structured format such as JSON or XML, among others, that facilitates efficient parsing and retrieval of individual properties by the version control layer 130. In some implementations, the metadata 404 can be updated when the version control layer 130 generates a new dataset version to reflect changes in dataset properties, while per-column metadata in the header storage 400 remains unchanged if the schema is stable. For example, the version control layer 130 can generate a new header file 121b in which the metadata 404 contains an updated version number property while the per-column metadata entries for column name 406a, column name 406b, and parent column name 406c retain the same values as the prior header file 121a, such that the content-addressable approach in the header storage layer 120 results in a distinct hash value for the new header file 121b due to the changed metadata 404 without requiring regeneration of column data in the data storage layer 110.

The header storage 400 can include per-column metadata for each column in a dataset version, where each column is represented by a set of four fields: a column name, a column datatype, a column nullability, and a column head. The header storage 400 stores this per-column metadata for a first column as column name 406a, column datatype 408a, column nullability 410a, and column head 412a, and for a second column as column name 406b, column datatype 408b, column nullability 410b, and column head 412b. The column name 406a and column name 406b can each be a text string identifier that distinguishes the respective column in the dataset schema, such as “input_text,” “target_value,” or “timestamp,” among others, such that the version control layer 130 can match each name to the corresponding chain of data blocks in the data storage layer 110. The column datatype 408a and column datatype 408b can each be a specification of the data type for values in the respective column, such as int64, utf8, float64, binary, or struct, among others, such that applications loading the dataset can allocate appropriate memory structures and apply correct parsing logic when reading column values. The column nullability 410a and column nullability 410b can each be a boolean flag indicating whether null values are permitted in the respective column, and the column nullability 410a and column nullability 410b can be set independently from one another, such that some columns in the dataset can permit null values while others do not. The column head 412a and column head 412b can each be a head identifier, such as a hash value, a file path, or a database key, among others, that points to a specific block in the chain of data blocks for the respective column in the dataset version represented by the header storage 400. In some implementations, the column head 412a and column head 412b can each point to a delta-encoded block rather than a full-data block, such that reconstruction of the respective column proceeds by traversing from the identified head block through the chain of data blocks to a full-data block 112 and executing delta operations along that path. The column head 412a and column head 412b can be updated independently from one another when creating a new dataset version, such that a column that was modified receives a new column head value pointing to a newly generated delta-encoded block 113a and/or delta-encoded block 113b, while a column that was not modified retains its existing column head value.

The header storage 400 can include per-column metadata for nested columns, where a parent column is represented by parent column name 406c, parent column datatype 408c, parent column nullability 410c, and parent column head 412c, and two child columns are represented by child column name 406d, child column datatype 408d, child column nullability 410d, and child column head 412d for the first child column, and by child column name 406e, child column datatype 408e, child column nullability 410e, and child column head 412e for the second child column. The parent column name 406c can be a text string identifier that identifies the parent column in the dataset schema, and the parent column datatype 408c can be a specification of a structured data type, such as struct, among others, that indicates the column contains nested data with child fields. In some implementations, the parent column datatype 408c can specify complex data types that represent database returns or other structured data while maintaining columnar storage and access patterns in the data storage layer 110. The parent column nullability 410c can be a boolean flag indicating whether null values are permitted for the entire structured data entry represented by the parent column, and the parent column nullability 410c can be set independently from child column nullability 410d and child column nullability 410e, such that the schema can represent scenarios where the entire structured entry is optional while individual child fields within non-null entries have distinct nullability constraints. The parent column head 412c can be a head identifier, such as a hash value, a file path, or a database key, among others, that points to a specific block in the chain of data blocks for the parent column in the dataset version represented by the header storage 400.

The child column name 406d and child column name 406e can each be a text string identifier that identifies the respective child field within the structured data represented by the parent column identified by parent column name 406c, such that the version control layer 130 can retrieve per-column metadata for each child column when reconstructing the nested data structure. The child column datatype 408d and child column datatype 408e can each be a specification of the data type for values in the respective child column, such as int64, utf8, float64, or binary, among others, and the child column datatype 408d and child column datatype 408e can each specify a different data type from one another, such that different child fields within the nested structure can carry different data types. The child column datatype 408d and child column datatype 408e can be stored in the header storage 400 using the same standardized type specification format as the parent column datatype 408c to provide consistent type specifications across all columns. The child column nullability 410d and child column nullability 410e can each be a boolean flag indicating whether null values are permitted in the respective child column, and the child column nullability 410d and child column nullability 410e can be set independently from one another and from the parent column nullability 410c, such that child fields within the same structured entry can have distinct nullability constraints. The child column head 412d and child column head 412e can each be a head identifier, such as a hash value, a file path, or a database key, among others, that points to a specific block in the chain of data blocks for the respective child column in the dataset version represented by the header storage 400. The child column head 412d and child column head 412e can each point to a separate chain of data blocks from the parent column head 412c, such that the version control layer 130 can maintain independent version histories for the parent column and each child column while preserving the parent-child relationships defined by the parent column name 406c, child column name 406d, and child column name 406e. In some implementations, the child column head 412d and child column head 412e can be updated independently from one another and from the parent column head 412c when the version control layer 130 generates a new dataset version, such that a child column that was modified receives a new child column head value pointing to a newly generated delta-encoded block 113a and/or delta-encoded block 113b, while child columns that were not modified retain their existing child column head values. The version control layer 130 can reconstruct the nested data structure for a requested dataset version by retrieving the parent column data from the block identified by parent column head 412c, retrieving the first child column data from the block identified by child column head 412d, and retrieving the second child column data from the block identified by child column head 412e, then combining all three according to the parent-child relationships defined in the header storage 400 to produce the complete nested structure.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

Some non-limiting embodiments of the present disclosure are described herein in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open ended terms. Further, the phrase “based on” is intended to mean “based at least partially on” unless explicitly stated otherwise.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A system for efficient storage and version control of machine learning datasets that reduces storage usage and reconstruction latency, the system comprising:
at least one processing resource; and
a computer-readable medium storing instructions that, when executed by the at least one processing resource, cause the system to:
store dataset information in a data storage layer in a columnar format comprising a plurality of columns, each column corresponding to a chain of data blocks comprising at least one full-data block and at least one delta-encoded block, the at least one delta-encoded block comprising operations to modify a preceding block;
store version metadata in a header storage layer, the version metadata comprising at least one header file of a plurality of content-addressable header files, the at least one header file representing a dataset version and comprising column metadata mapping at least one column to a head block in the chain of data blocks;
generate, in response to a commit request comprising changes relative to a prior dataset version, at least one new delta-encoded block in the chain of data blocks for at least one column identified as modified and a new header file representing a new dataset version, the new header file comprising column metadata mapping the at least one column to a head block in the chain of data blocks; and
in response to a query for a requested dataset version, reconstruct data for at least one column by identifying a header file corresponding to the requested dataset version and processing delta-encoded blocks in the chain of data blocks for the at least one column relative to a full-data block.

2. The system of claim 1, wherein the chain of data blocks for at least one column further comprises a main-head block comprising a full encoding of the at least one column, and the instructions that, when executed by the at least one processing resource, cause the system to:
select the main-head block as a reference block for reconstructing data for a plurality of dataset versions for the at least one column; and
process, for the plurality of dataset versions, delta-encoded blocks in the chain of data blocks relative to the main-head block to obtain reconstructed data.

3. The system of claim 2, wherein migrating the main-head block comprises:
monitoring version metadata for a plurality of dataset versions to determine at least one usage metric comprising at least one of a number of accesses to a dataset version and a length of a delta chain from the main-head block; and
selecting, as a new main-head block, a full-data block in the chain of data blocks for the at least one column in response to the at least one usage metric satisfying a trigger condition comprising at least one of exceeding a threshold number of accesses and exceeding a threshold delta chain length, and updating the version metadata to record the new main-head block.

4. The system of claim 1, wherein the full-data block for at least one column comprises data encoded in a first storage format, and the instructions that, when executed by the at least one processing resource, cause the system to:
store the full-data block encoded in a compressed storage format in a first storage environment associated with a repository server; and
store a corresponding full-data block for the at least one column encoded in a second storage format optimized for memory-mapped access in a second storage environment associated with an inference server.

5. The system of claim 1, wherein the operations of the at least one delta-encoded block comprise:
a keep operation specifying a range of keep rows by an offset and a count configured to execute during reconstruction by copying values from the prior dataset version for the range of keep rows without decoding additional data;
a delete operation specifying a range of delete rows to be removed from a prior dataset version configured to execute during reconstruction by removing the range of delete rows;
an update operation comprising replacement data values encoded in a compressed format configured to execute during reconstruction by decoding the replacement data values and overwriting corresponding values obtained from a full-data block or a prior delta-encoded block; and
an insert operation comprising insert data values encoded in the compressed format, and at least one location, the insert operation configured to execute during reconstruction by decoding the insert data values and placing the insert data values at the at least one location.

6. The system of claim 1, wherein at least one column comprises a nested data type comprising a parent column and at least one child column, and the instructions that, when executed by the at least one processing resource, cause the system to:
store the nested data type as a plurality of chains of data blocks comprising a chain for the parent column and a chain for the at least one child column; and
propagate, during reconstruction of the nested data type, an operation, triggered on the parent column, to the at least one child column.

7. The system of claim 1, wherein generating the at least one delta-encoded block comprises:
reconstructing data for the prior dataset version for the plurality of columns based at least on a header file representing the prior dataset version;
comparing local data for the plurality of columns with reconstructed data for the prior dataset version to determine a subset of columns identified as modified; and
generating the at least one delta-encoded block for the subset of columns, the at least one delta-encoded block corresponding to an operation configured to generate a current full-data block for a current dataset version.

8. The system of claim 1, wherein storing the version metadata further comprises:
associating at least one header file with branch metadata identifying a branch name and a parent dataset version; and
maintaining, in the header storage layer, a directed acyclic graph of dataset versions comprising a base dataset version and a plurality of child dataset versions, each child dataset version recorded with a reference to a parent header file in the directed acyclic graph.

9. The system of claim 8, wherein merging dataset versions comprises:
identifying a first branch and a second branch comprising different sequences of header files extending from a common ancestor dataset version;
determining differences between a latest dataset version of the first branch and a most latest version of the second branch for at least one column; and
generating a merged dataset version comprising a merged header file and at least one delta-encoded block encoding merged changes relative to the common ancestor dataset version.

10. The system of claim 1, wherein reconstructing data for the requested dataset version comprises:
receiving a query specifying a subset of columns for the requested dataset version;
identifying column metadata in a header file corresponding to the requested dataset version for only the subset of columns; and
reconstructing data only for the subset of columns by processing delta-encoded blocks in the chain of data blocks corresponding to the subset of columns.

11. A method for efficient storage and version control of machine learning datasets that reduces storage usage and reconstruction latency, comprising:
storing dataset information in a data storage layer in a columnar format comprising a plurality of columns, each column corresponding to a chain of data blocks comprising at least one full-data block and at least one delta-encoded block, the at least one delta-encoded block comprising operations to modify a preceding block comprising at least one of at least one keep operation, at least one delete operation, at least one update operation, and at least one insert operation;
storing version metadata in a header storage layer, the version metadata comprising a plurality of content-addressable header files, at least one header file representing a dataset version and comprising column metadata mapping at least one column to a head block in the chain of data blocks;
generating, in response to a commit request comprising changes relative to a prior dataset version, at least one new delta-encoded block in the chain of data blocks for at least one column identified as modified and a new header file representing a new dataset version, the new header file comprising column metadata mapping the at least one column to a head block in the chain of data blocks; and
in response to a query for a requested dataset version, reconstructing data for at least one column for a requested dataset version by identifying a header file corresponding to the requested dataset version and processing delta-encoded blocks in the chain of data blocks for the at least one column relative to a full-data block.

12. The method of claim 11, further comprising:
storing, for at least one column, a main-head block in the chain of data blocks, the main-head block comprising a full encoding of the at least one column;
selecting the main-head block as a reference block for reconstructing data for a plurality of dataset versions for the at least one column; and
processing, for the plurality of dataset versions, delta-encoded blocks in the chain of data blocks relative to the main-head block to obtain reconstructed data.

13. The method of claim 12, further comprising:
monitoring version metadata for a plurality of dataset versions to determine at least one usage metric comprising at least one of a number of accesses to a dataset version and a length of a delta chain from the main-head block; and
selecting, as a new main-head block, a full-data block in the chain of data blocks for the at least one column in response to the at least one usage metric satisfying a trigger condition comprising at least one of exceeding a threshold number of accesses and exceeding a threshold delta chain length, and updating the version metadata to record the new main-head block.

14. The method of claim 11, further comprising:
encoding a full-data block for at least one column in a first storage format;
storing the full-data block encoded in a compressed storage format in a first storage environment associated with a repository server; and
storing a corresponding full-data block for the at least one column encoded in a second storage format optimized for memory-mapped access in a second storage environment associated with an inference server.

15. The method of claim 11, wherein the operations of the at least one delta-encoded block for at least one column comprise a keep operation specifying a range of keep rows by an offset and a count, a delete operation specifying a range of delete rows, an update operation comprising replacement data values encoded in a compressed format, and an insert operation comprising insert data values encoded in the compressed format and at least one location, the method further comprising:
executing the keep operation during reconstruction by copying values from the prior dataset version for the range of keep rows without decoding additional data;
executing the delete operation during reconstruction by removing the range of delete rows from reconstructed data;
executing the update operation during reconstruction by decoding the replacement data values and overwriting corresponding values obtained from a full-data block or a prior delta-encoded block; and
executing the insert operation during reconstruction by decoding the insert data values and placing the insert data values at the at least one location.

16. The method of claim 11, wherein generating the at least one delta-encoded block comprises:
reconstructing data for the prior dataset version for a plurality of columns based at least on a header file representing the prior dataset version;
comparing local data for the plurality of columns with reconstructed data for the prior dataset version to determine a subset of columns identified as modified; and
generating the at least one delta-encoded block for the subset of columns, the at least one delta-encoded block corresponding to an operation configured to generate a current full-data block for a current dataset version.

17. The method of claim 11, further comprising:
associating at least one header file with branch metadata identifying a branch name and a parent dataset version;
maintaining, in the header storage layer, a directed acyclic graph of dataset versions comprising a base dataset version and a plurality of child dataset versions, each child dataset version recorded with a reference to a parent header file in the directed acyclic graph;
identifying a first branch and a second branch comprising different sequences of header files extending from a common ancestor dataset version;
determining differences between a latest dataset version of the first branch and a latest dataset version of the second branch for at least one column; and
generating a merged dataset version comprising a merged header file and at least one delta-encoded block encoding merged changes relative to the common ancestor dataset version.

18. The method of claim 11, wherein reconstructing data for the requested dataset version comprises:
receiving a query specifying a subset of columns for the requested dataset version;
identifying column metadata in a header file corresponding to the requested dataset version for only the subset of columns; and
reconstructing data only for the subset of columns by processing delta-encoded blocks in chains of data blocks corresponding to the subset of columns.

19. A non-transitory, computer-readable medium comprising instructions that, when executed by at least one processing resource, cause the at least one processing resource to:
store dataset information in a data storage layer in a columnar format comprising a plurality of columns, each column corresponding to a chain of data blocks comprising at least one full-data block and at least one delta-encoded block, the at least one delta-encoded block comprising operations to modify a preceding block comprising at least one of at least one keep operation, at least one delete operation, at least one update operation, and at least one insert operation;
store version metadata in a header storage layer, the version metadata comprising a plurality of content-addressable header files, at least one header file representing a dataset version and comprising column metadata mapping at least one column to a head block in the chain of data blocks;
generate, in response to a commit request comprising changes relative to a prior dataset version, at least one new delta-encoded block in the chain of data blocks for at least one column identified as modified and a new header file representing a new dataset version, the new header file comprising column metadata mapping the at least one column to a head block in the chain of data blocks; and
in response to a query for a requested dataset version, reconstruct data for at least one column for a requested dataset version by identifying a header file corresponding to the requested dataset version and processing delta-encoded blocks in the chain of data blocks for the at least one column relative to a full-data block.

20. The non-transitory, computer-readable medium of claim 19, wherein the instructions, when executed by the at least one processing resource, further cause the at least one processing resource to:
store, for at least one column, a main-head block in the chain of data blocks, the main-head block comprising a full encoding of the at least one column;
select the main-head block as a reference block for reconstructing data for a plurality of dataset versions for the at least one column; and
process, for the plurality of dataset versions, delta-encoded blocks in the chain of data blocks relative to the main-head block to obtain reconstructed data.
